(19) United States
(12) Patent Application Publication
(10) Pub. No.: US 2025/0125445 A1
(43) Pub. Date: Apr. 17, 2025

(54) MOVABLE BATTERY SYSTEM

(71) Applicants: HYUNDAI MOTOR COMPANY, Seoul (KR); KIA CORPORATION, Seoul (KR)

(72) Inventor: Il Suk Yang, Hwaseong-si (KR)

(73) Assignees: HYUNDAI MOTOR COMPANY, Seoul (KR); KIA CORPORATION, Seoul (KR)

(21) Appl. No.: 18/667,198

(22) Filed: May 17, 2024

(30) Foreign Application Priority Data
Oct. 11, 2023 (KR) 10-2023-0134897

(51) Int. Cl. H01M 10/6568; B60R 16/04; H01M 10/6569; H01M 10/657

(52) U.S. Cl. CPC H01M 10/6568; B60R 16/04; H01M 10/6569; H01M 10/657

(57) ABSTRACT

A movable battery system, which is separately configured from a main battery system provided in a main vehicle, performs an independent charging and discharging as well as thermal management of an auxiliary battery to increase a maximal total driving range of the main vehicle. The battery system includes: a battery providing electric power for driving the main vehicle; a first coolant line connecting the battery, a power conversion module, a radiator and a water pump; a second coolant line branching from the first coolant line; and a third coolant line branching from the second coolant line. The battery system includes further includes: a first coolant control valve provided at a branch point of the second coolant line, a second coolant control valve provided at a branch point of the third coolant line, and a controller controlling an operation mode of the first and second coolant control valves.

### CROSS REFERENCE TO RELATED APPLICATION

The present application claims priority to Korean Patent Application No. 10-2023-0134897, filed on Oct. 11, 2023, the entire contents of which are incorporated herein by reference.

### BACKGROUND

### Technical Field

The present disclosure relates to a movable battery system and, more particularly, to a movable battery system that is selectively connected to a vehicle.

### Description of the Related Art

Recently, demand for electric vehicles has been expanding, and this expansion in demand is expected to continue in the future.

In the case of electric vehicles, it is desired to install large-capacity batteries in order to increase the maximal total driving range (i.e., the farthest distance that an electric vehicle can travel on a single charge of its battery) of such electric vehicles, but there are difficulties in installing large-capacity batteries in the case of small electric vehicles since there is a relative lack of space for batteries.

In addition, when a battery with a larger capacity than a basic capacity is mounted on a vehicle, the production cost is increased since an increase in battery capacity causes an increase in the production cost of the vehicle.

Accordingly, an auxiliary battery may be installed in an electric vehicle and connected to a main battery only when it is necessary to extend the vehicle's maximal total driving range, such as when driving long distances. Otherwise, the capacity of the main battery installed in the electric vehicle is set to the basic capacity capable of carrying out the basic maximal total driving range.

However, conventionally, an auxiliary battery is simply connected to and mounted on a vehicle on which a main battery is mounted, and there is no dedicated thermal management circuit to enhance the performance of the auxiliary battery.

The statements in this BACKGROUND section merely provide background information related to the present disclosure and may not constitute prior art.

### SUMMARY

The present disclosure is devised in consideration of the above problems and aims to provide a movable battery system that performs an independent charging and discharging as well as thermal management of an auxiliary battery in order to increase the maximal total driving range of a main vehicle. In particular, the auxiliary battery is separately configured from a main battery system provided in the main vehicle.

The objective of the present disclosure is not limited to the above-mentioned objective, and other objectives of the present disclosure not mentioned above may be clearly understood by those having ordinary skill in the art from the following description.

In order to achieve the above objective, the present disclosure provides a movable battery system that includes an auxiliary vehicle connectable to a main vehicle, and a battery system mounted on the auxiliary vehicle. In particular, the battery system mounted on the auxiliary vehicle includes: a battery that provides power for driving the main vehicle; a first coolant line that connects the battery, a power conversion module, a radiator, and a water pump in order to enable circulation of a coolant through the first coolant line; and a second coolant line that branches from the first coolant line between the radiator and the power conversion module and is connected to the first coolant line between the radiator and the water pump. The battery system further includes a third coolant line that branches from the second coolant line, is connected to the first coolant line between the battery and the power conversion module, and selectively allows coolant to flow to a thermal management module for thermal management of the battery. The battery system further includes: a first coolant control valve that is provided at a branch point of the second coolant line and controls the flow of a coolant, a second coolant control valve that is provided at a branch point of the third coolant line and controls the flow of a coolant, and a controller that controls an operation mode of the first coolant control valve and the second coolant control valve.

According to an embodiment of the present disclosure, the first coolant control valve may include a first port connected to the front end of the radiator, a second port connected to the rear end of the power conversion module, and a third port connected to the front end of the water pump. The second coolant control valve includes a fourth port connected to the rear end of the thermal management module, a fifth port connected to the front end of the water pump, and a sixth port connected to the third port. In addition, the thermal management module may include a heater to selectively heat the coolant transferred from the battery and a chiller to cool a coolant through heat exchange with a refrigerant.

In addition, according to an embodiment of the present disclosure, the chiller may be connected to an electric compressor, an external condenser, and an electronic expansion valve through a refrigerant line, and the external condenser may transfer the refrigerant that has exchanged heat with the outside air to the front end of the chiller.

In addition, the battery is characterized by being cooled through the chiller and the radiator by the first coolant control valve controlled to open the first and second ports and to close the third port as well as the second coolant control valve controlled to open the fourth and fifth ports and to close the sixth port.

In addition, the electronic expansion valve may be disposed at the front end of the chiller and may be controlled to cool the refrigerant transferred from the external condenser by decompressing the refrigerant.

In addition, the battery may be cooled through the radiator by the first coolant control valve controlled to open the first and second ports and to close the third port as well as the second coolant control valve controlled to close at least the fifth port.

In addition, the temperature of the battery may be increased through heat generated by the power conversion module by the first coolant control valve controlled to close the first port and to open the second and third ports as well as the second coolant control valve controlled to close the fourth port and to open the fifth port and the sixth port.

In addition, the temperature of the battery may be increased through heat generation of the power conversion module and the driving of the heater by the first coolant control valve controlled to close the first port and to open the second port and the third port as well as the second coolant control valve controlled to open the fourth port, the fifth port, and sixth port.

According to the present disclosure, independent thermal management and charging and discharging of the battery may be performed through a thermal management module and a power conversion module separately provided from a main battery system mounted on a main vehicle.

In addition, according to the present disclosure, the battery may be cooled or heated within an optimal temperature range by controlling the flow of coolant through a coolant control valve according to external temperature conditions, thereby maintaining the temperature of the battery within the optimal temperature range.

The effects of the present disclosure are not limited to the above effects, and other effects of the present disclosure not mentioned should be clearly understood by those having ordinary skill in the art from the following description.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is a schematic view showing a state in which a movable battery system according to an embodiment of the present disclosure is connected to a main vehicle;

FIG. 2 is a plan view showing a component arrangement structure of a movable battery system according to an embodiment of the present disclosure;

FIG. 3 is a side view showing a component arrangement structure of a movable battery system according to an embodiment of the present disclosure;

FIG. 4 is a view showing a circuit configuration of an auxiliary battery system according to an embodiment of the present disclosure; and

FIGS. 5 to 8 are views respectively illustrating a coolant flow path according to an operation mode of an auxiliary battery system in an embodiment of the present disclosure.

### DETAILED DESCRIPTION

Hereinafter, embodiments of the present disclosure are described with reference to the accompanying drawings. Matters included in the accompanying drawings are schematically illustrated to easily explain some embodiments of the present disclosure and may be different from the actual implemented form.

In addition, terms such as “a first” and “a second” can be used to describe various components in this specification, but the above components are not limited by the above terms. The terms are used to distinguish one component from other components. For example, the first component may be referred to as the second component, and the second component may be referred to as the first component without departing from the scope of rights under the concepts of the present disclosure.

In addition, terms such as “front”, “rear”, “upstream”, “downstream”, “outlet”, and “inlet” in this specification are based on the flow direction of fluids such as coolant or refrigerant, unless otherwise stated. When a component, device, element, or the like of the present disclosure is described as having a purpose or performing an operation, function, or the like, the component, device, or element should be considered herein as being “configured to” meet that purpose or to perform that operation or function.

According to an embodiment of the present disclosure, as illustrated in FIG. 1, a movable battery system includes: an auxiliary vehicle 20 connected to a main vehicle 10; and an auxiliary battery system 100 mounted on the auxiliary vehicle 20.

The main vehicle 10 is provided with a drive motor 12 as its propulsion source for travel, a main battery 16 providing electric power to the drive motor 12, and a main battery system 14 including the main battery 16. The main battery system 14 is configured to perform thermal management of the main battery 16.

The main vehicle 10 may be selectively connected to the auxiliary vehicle 20 in order to increase a maximal total driving range of the main vehicle.

The auxiliary vehicle 20 is not provided with a separate traveling driving source such as an internal combustion engine or an electric motor and may be driven by being mechanically connected to the main vehicle 10. In other words, the auxiliary vehicle 20 may not actively drive, and instead is towed by the main vehicle 10 to drive passively. For this purpose, the auxiliary vehicle 20 is provided with at least one pair of wheels 26. The auxiliary vehicle 20 may be a type of trailer being towed by the main vehicle 10.

Referring to FIG. 1, the auxiliary vehicle 20 may include a vehicle body 22 having an internal space in which the auxiliary battery system 100 is mounted, and a cover 24 for opening and closing the internal space of the vehicle body 22.

The auxiliary battery system 100 is configured to construct a circuit independent of the main battery system 14 and perform independent thermal management. For example, the auxiliary battery system 100 may separately perform thermal management such as cooling and heating of the auxiliary battery 110 regardless of the main battery system 14.

The auxiliary battery 110 may be electrically connected to the main battery 16 or electrically connected to the drive motor 12 in order to be used as a power supply source for the driving and traveling of the main vehicle 10. For example, when the auxiliary vehicle 20 is connected to the main vehicle 10 through a mechanical connector, the auxiliary battery 110 may be connected to the main battery 16 through a separate electrical connection method.

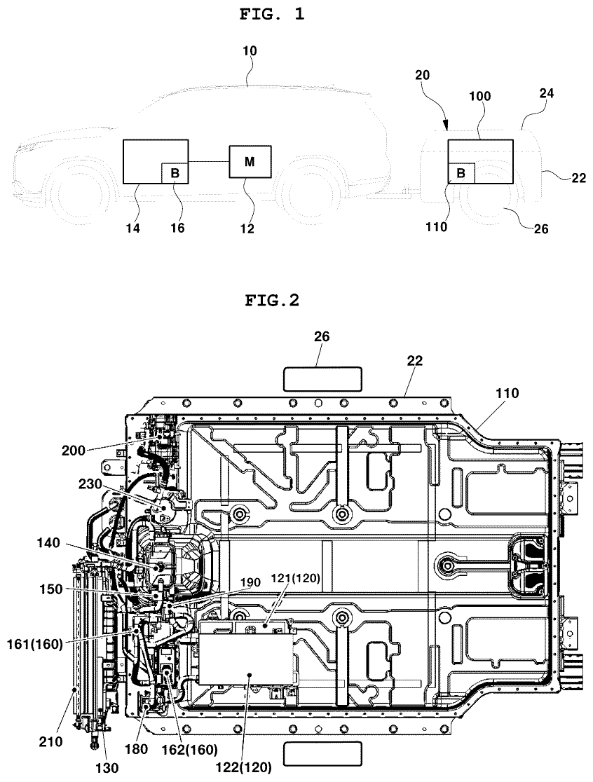

Hereinafter, referring to FIGS. 2 to 8, a movable battery system according to an embodiment of the present disclosure is described in more detail.

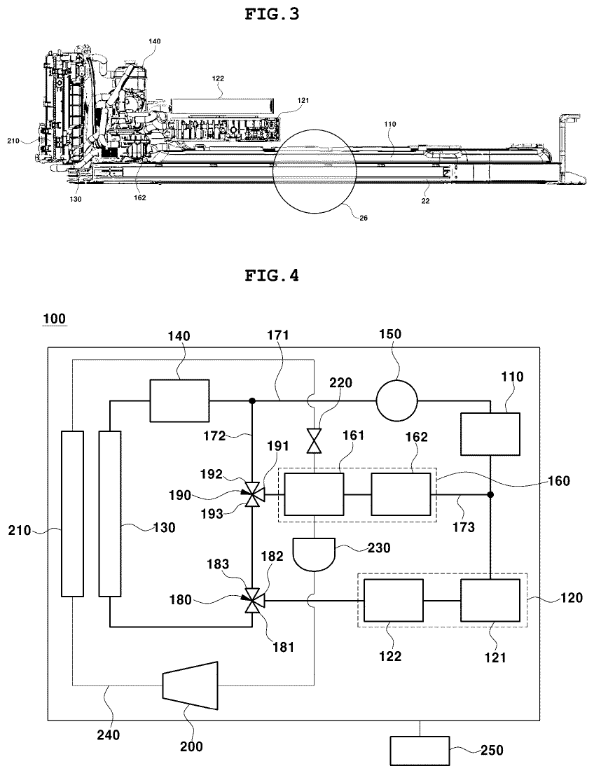

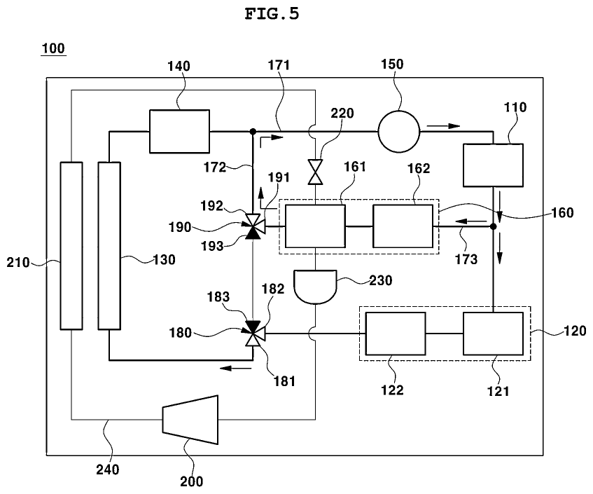

FIGS. 2 and 3 are a plan view and a side view showing a component arrangement structure of an auxiliary battery system 100 arranged within a vehicle body 22 of an auxiliary vehicle 20, FIG. 4 is a view showing a circuit configuration of an auxiliary battery system 100, FIGS. 5 to 8 are views respectively showing a coolant flow path according to an operation mode of the auxiliary battery system 100.

In addition, unless otherwise stated, it should be noted that “battery 110” means the auxiliary battery 110, “vehicle 20” means the auxiliary vehicle 20, and “battery system 100” means the auxiliary battery system 100.

The battery system 100 includes a battery 110 and components for thermal management and power conversion of the battery 110.

Referring to FIGS. 2 and 3, all components other than the battery 110 among the components of the battery system 100 may be concentrically disposed at the front of the vehicle body 22. This is for securing driving stability by making the center of gravity of the vehicle 20 located in the front based on the rotation center of a wheel 26, for example, for reducing the fluctuation of the vehicle 20 due to a lateral yaw force. At this time, the battery 110 is disposed entirely in the lower space of the vehicle body 22, and other components except the battery 110 are disposed in the upper space of the vehicle body 22.

The battery system 100 allows the rear space of the vehicle 20 to be utilized as a multi-purpose space by concentrating other components except the battery 110 in the front of the vehicle 20.

In addition, in the battery system 100, the radiator 130 for cooling the battery 110 and the external condenser 210 are disposed in the front of the vehicle body 22 and at the same time are disposed to be biased to one side of the left and right side of the vehicle body 22. This is for allowing the radiator 130 and the external condenser 210 to cool the coolant and refrigerant by utilizing the inflow of the side-driving wind. The inflow of driving winds is not readily available since the auxiliary vehicle 20 is located and towed at the rear of the main vehicle 10. Accordingly, the inflow of the driving wind is facilitated through a one-sided arrangement of the radiator 130 and the external condenser 210. In addition, at least a part of the radiator 130 and the external condenser 210 are located and exposed outside the vehicle body 22 so that the inflow of the outside air is possible.

In addition, the components required for refrigerant circulation among the components of the battery system 100 may be disposed on the opposite side of the radiator 130 and the external condenser 210. This is for facilitating the the configuration of the refrigerant circuit by resolving excessive density of components and securing a gap with the external condenser 210. Components for the refrigerant circulation may include an electric compressor 200 and an accumulator 230.

For example, when the radiator 130 and the external condenser 210 are disposed on the left side, the electric compressor 200 and the accumulator 230 may be disposed on the right.

Referring to FIG. 4, the battery system 100 includes a battery 110 subject to thermal management, a power conversion module 120 subject to cooling, coolant lines 171, 172, 173 through which coolant for cooling them is circulated, and a refrigerant line 240 through which refrigerant for heat exchange with coolant is circulated.

The battery 110 is a major component to provide power to a main vehicle 10, and it is necessary to maintain an optimal temperature for its performance improvement. The optimal temperature range is about 15° C. to 38° C. to improve the charging performance and the discharging performance of the battery 110.

The power conversion module 120 is a component for converting and controlling the power discharged from the battery 110 and the power charged into the battery 110, and cooling of the heat generated during its operation is necessary. The power conversion module 120 is required to be cooled to about 100° C. or lower for normal operation.

In one embodiment, the power conversion module 120 includes an integrated charge control unit (ICCU) 121 for converting and controlling the charging power of the battery 110 and a bi-direction high voltage DC converter (BHDC) 122 for converting the incoming and outgoing power of the battery 110. The ICCU 121 and the BHDC 122 are connected in series through a first coolant line 171.

The battery 110 and the power conversion module 120 are connected in order to enable coolant to be circulated by the first coolant line 171, and are also connected to a radiator 130, a reservoir tank 140, and an electric water pump 150. In other words, the battery 110, the power conversion module 120, the radiator 130, the reservoir tank 140, and the electric water pump 150 are connected in series through the first coolant line 171 in order to enable coolant to be circulated.

The water pump 150 is driven and controlled by a controller 250 and is configured to circulate the coolant stored and recovered in the reservoir tank 140 to the first coolant line 171. The coolant transferred from the water pump 150 first flows into the battery 110. The controller 250 is a battery system controller that performs overall control of the battery system 100.

The radiator 130 is disposed at the rear end and downstream of the battery 110 and the power conversion module 120 in the first coolant line 171, and is disposed at the front end and upstream of the reservoir tank 140 and the water pump 150. The radiator 130 serves to cool a heated coolant while passing through the battery 110 and the power conversion module 120. The radiator 130 may cool the coolant through heat exchange with the outside air.

A second coolant line 172 and a third coolant line 173 are branched and provided in the first coolant line 171.

The second coolant line 172 is branched from the first coolant line 171 between the radiator 130 and the battery 110 and connected to the first coolant line 171 between the radiator 130 and the water pump 150. Specifically, a first end of the second coolant line 172 is connected to the first coolant line 171 between the power conversion module 120 and the radiator 130, and a second end of the second coolant line 172 is connected to the first coolant line 171 between the reservoir tank 140 and the water pump 150. In other words, the second coolant line 172 is connected to the front end of the radiator 130 and the rear end of the reservoir tank 140 in order to enable coolant to flow.

A third coolant line 173 is branched from the second coolant line 172 and connected to the first coolant line 171 between the battery 110 and the power conversion module 120. That is, a first end of the third coolant line 173 is connected to a middle point of the second coolant line 172, and a second end of the third coolant line 173 is connected to the first coolant line 171 between the rear end of the battery 110 and the front end of the power conversion module 120.

The third coolant line 173 is connected to a thermal management module 160 for thermal management of the battery 110 and is provided to selectively flow and circulate the coolant. For this purpose, a first coolant control valve 180 and a second coolant control valve 190 are provided at a branch point of the first coolant line 171 and a branch point of the second coolant line 172, respectively.

The thermal management module 160 manages the temperature of the battery 110 and includes a chiller 161 and a heater 162. The chiller 161 and the heater 162 are connected through a third coolant line 173 in series in order to enable coolant to flow.

The chiller 161 as a cooling device using a refrigerant is configured to enable the coolant and the refrigerant to exchange heat with each other while passing through. The coolant passing through the chiller 161 may be cooled through heat exchange with the refrigerant, and the battery 110 and the power conversion module 120 may be cooled through the coolant cooled by the chiller 161.

The heater 162 as an electrically heating heat-riser is configured to directly heat and transfer coolant passing through the heater 162. The heater 162 selectively heats the coolant by a control of the controller 250.

Referring to FIG. 4, the first coolant control valve 180 is installed at a branch point where the second coolant line 172 is branched from the first coolant line 171, and the second coolant control valve 190 is installed at a branch point where the third coolant line 173 is branched from the second coolant line 172. That is, a first end of the second coolant line 172 is connected to the first coolant line 171 through the first coolant control valve 180, and a first end of the third coolant line 173 is connected to the second coolant line 172 through the second coolant control valve 190.

The first coolant control valve 180 includes a first port 181 connected to the front end of the radiator 130, a second port 182 connected to the rear end of the power conversion module 120, and a third port 183 connected to the front end of the water pump 150. The first port 181 is connected to the front end of the radiator 130 through the first coolant line 171 and is selectively opened by the control of a controller 250 so that coolant is transferred. The second port 182 is connected to the rear end of the power conversion module 120 through the first coolant line 171 and is selectively opened by the control of the controller 250 so that coolant flows in. The third port 183 is connected to the first coolant line 171 between the radiator 130 and the water pump 150 through the second coolant line 172 and the second coolant control valve 190.

The second coolant control valve 190 includes a fourth port 191 connected to the rear end of the thermal management module 160, a fifth port 192 connected to the front end of the water pump 150, and a sixth port 193 connected to the third port 183. The fourth port 191 is connected to the rear end of the thermal management module 160 through the third coolant line 173, and coolant flows in when the fourth port is opened by the controller 250. The fifth port 192 is connected to the first coolant line 171 at the front end of the water pump 150 through the second coolant line 172 and transfers coolant when opened by the controller 250. The sixth port 193 is connected to the third port 183 through the second coolant line 172 and transfers coolant toward the third port 183 when opened by the controller 250.

Each port 181, 182, 183 of the first coolant control valve 180 and each port 191, 192, 193 of the second coolant control valve 190 are selectively opened and closed by the control of the controller 250, and coolant may flow in and out when opened. In other words, the coolant flow of the coolant lines 171, 172, 173 is controlled by the controller 250 to control operation modes of the first coolant control valve 180 and the second coolant control valve 190. A three-way valve may be applied to the coolant control valves 180, 190.

Meanwhile, the refrigerant line 240 connected to the chiller 161 connects an electric compressor 200, the external condenser 210, and an electronic expansion valve 220 in series in order to enable circulation and flow of the refrigerant through the refrigerant line 240. In other words, the refrigerant line 240 connects the electric compressor 200, the external condenser 210, the electronic expansion valve 220, the chiller 161 and an accumulator 230 in series.

The electric compressor 200 is configured to compress and circulate the refrigerant in the refrigerant line 240. The refrigerant transferred from the compressor 200 is supplied to the external condenser 210 located at the rear end of the compressor 200.

The external condenser 210 is configured to radiate heat and cool the refrigerant through heat exchange with the outside air while the refrigerant passes through and flows. The refrigerant transferred from the external condenser 210 flows into the electronic expansion valve 220 located at the rear end of the external condenser 210.

The expansion valve 220 which cools the refrigerant while expanding the refrigerant through decompression of the refrigerant is installed in the refrigerant line 240 between the chiller 161 and the external condenser 210. The expansion valve 220 is configured to expand the refrigerant or to simply pass the refrigerant without expanding the refrigerant by adjusting the opening amount of the refrigerant flow path within the valve via the controller 250. The refrigerant passing through the expansion valve 220 flows into the chiller 161 located at the rear end thereof.

The refrigerant flowing into the chiller 161 is cooled to a temperature lower than the temperature of the outside air when being first cooled in the external condenser 210 and then secondarily cooled in the expansion valve 220. Accordingly, the coolant passing through the chiller 161 may be cooled to a temperature lower than the temperature of the outside air through heat exchange with the refrigerant.

The refrigerant that has passed through the chiller 161 flows again into the compressor 200 and is recovered after passing through an accumulator 230. The accumulator 230 collects liquid refrigerant among refrigerants transferred from the chiller 161 and transfers only gaseous refrigerant to the compressor 200.

The battery system 100 described above may be operated in a certain mode set by the controller 250 based on the temperature condition of the outside air as shown in FIGS. 5 to 8.

As shown in FIG. 5, a battery system 100 according to an embodiment of the present disclosure may be operated in a first cooling mode that uses both a chiller 161 and a radiator 130.

When the outside temperature is equal to or higher than a first temperature which is determined as the high temperature, cooling is required utilizing both the chiller 161 and the radiator 130. The first temperature may be determined as a temperature value at which it is not possible to secure cooling performance through the radiator 130. In other words, the first temperature may be determined as a temperature value at which it is required to cool a battery 110 using both the radiator 130 and the chiller 161. For example, the first temperature may be 25° C.

In order to control the battery system 100 in the first cooling mode using the chiller 161, a first coolant control valve 180 is controlled to open a first port 181 and a second port 182 and to close a third port 183, and a second coolant control valve 190 is controlled to open a fourth port 191 and a fifth port 192 and to close a sixth port 193.

Accordingly, the rear end of the chiller 161 is connected to a first coolant line 171 between the radiator 130 and the battery 110 through the second coolant control valve 190 and a second coolant line 172. The rear end of a power conversion module 120 is connected to an inlet of the radiator 130 through a first coolant control valve 180 and the first coolant line 171.

Therefore, the coolant cooled through the chiller 161 flows first into the battery 110 among the heat-generating components, and the coolant cooled through the radiator 130 flows first into the battery 110 as well.

At this time, the coolant cooled by the chiller 161 and the coolant cooled by the radiator 130 join at the front end of a water pump 150 and flow toward the battery 110, thereby cooling while passing through the battery 110. Subsequently, the coolant that has passed through the battery 110 branches off and flows toward a thermal management module 160 and the power conversion module 120 at the rear end of the battery 110.

In this way, the coolant may be cooled below the outside temperature by using the chiller 161 along with the radiator 130 for cooling the battery 110. This is because the refrigerant being first cooled in an external condenser 210 and then secondarily cooled by an expansion valve 220 flows into the chiller 161.

In the case of the power conversion module 120, cooling is achieved solely through the radiator 130, thereby reducing or alleviating the cooling load of the chiller 161. In addition, because the coolant passing through the radiator 130 first passes through the battery 110 and then passes through the power conversion module 120, the effects of the heat, generated from the power conversion module 120, on the cooling of the battery 110 may be minimized.

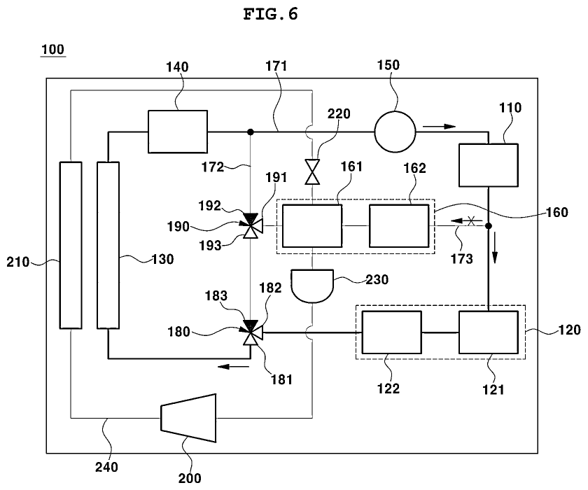

Meanwhile, a battery system 100 according to an embodiment of the present disclosure may be operated in a second cooling mode using a radiator 130 as shown in FIG. 6.

When the outside temperature is equal to or greater than a predetermined second temperature and less than the first temperature, it is possible to cool a battery 110 and a power conversion module 120 only with a radiator 130. The second temperature lower than the first temperature may be determined as a temperature value at which it is possible to cool the battery 110 and the power conversion module 120 using only the radiator 130 without the use of a chiller 161. The second temperature may be, for example, 15° C.

In order to control the battery system 100 in the second cooling mode which uses only the radiator 130, the coolant flow to a third coolant line 173 which is for the coolant flow of the chiller 161 is blocked.

For this purpose, a second coolant control valve 190 may be controlled to close all of the ports 191, 192, 193, or may be controlled to close at least the fifth port 192 even when a fourth port 191 and a sixth port 193 are opened. A first coolant control valve 180 is controlled to open a first port 181 and a second port 182 and to close a third port 183.

Accordingly, the rear end of the power conversion module 120 is connected to the front end of the radiator 130 through the first coolant control valve 180, and the coolant flow through a second coolant line 172 and the third coolant line 173 is blocked.

Therefore, the coolant is circulated only in a first coolant line 171, and the battery 110 and the power conversion module 120 are cooled only by the coolant passing through the radiator 130.

In this case, the chiller 161 is not used for cooling the battery 110 and the power conversion module 120. Accordingly, a compressor 200 of a refrigerant line 240 may not be operated and power consumption may be reduced.

In addition, the flow rate of the coolant may increase and the cooling performance may be supplemented because the battery 110, the power conversion module 120, and the radiator 130 are all connected in series through the first coolant line 171 even when the cooling through the chiller 161 is not performed.

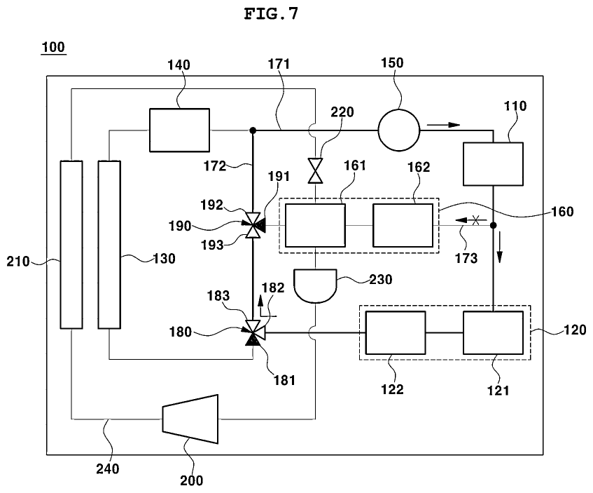

On the other hand, as shown in FIG. 7, a battery system 100 according to an embodiment of the present disclosure may be operated in a first heating mode using heat generation of a power conversion module 120.

When the outside temperature is equal to or higher than a predetermined third temperature and is less than the second temperature, the temperature of a battery 110 needs to be increased to improve the performance of the battery 110. If the temperature is above zero even when the outside temperature is low, it is possible to raise the temperature of the battery 110 within the optimal temperature range through heat generated from the power conversion module 120 without using a heater 162. The third temperature lower than the second temperature may be determined as a temperature value to which it is possible to raise the temperature of the battery 110 only with heat generation of the power conversion module 120. The third temperature may be, for example, determined as 0° C.

In order to control the battery system 100 in the first heating mode that uses only the heat generated from the power conversion module 120, the coolant flow in a third coolant line 173 is blocked.

For this purpose, the first coolant control valve 180 is controlled to close a first port 181 and to open a second port 182 and a third port 183, and a second coolant control valve 190 is controlled to close a fourth port 191 and open a fifth port 192 and a sixth port 193.

Accordingly, only the battery 110, the power conversion module 120, and a water pump 150 are connected in series in order to enable coolant to flow. Therefore, the coolant passing through the power conversion module 120 does not flow toward a radiator 130, but directly flows into an inlet of the battery 110 through a second coolant line 172.

By this, heat from the power conversion module 120 is transferred directly to the battery 110 with little loss, and the temperature of the battery 110 may be raised within a determined optimal temperature range without the use of the heater 162. In addition, power consumption is reduced because the heater 162 is not used.

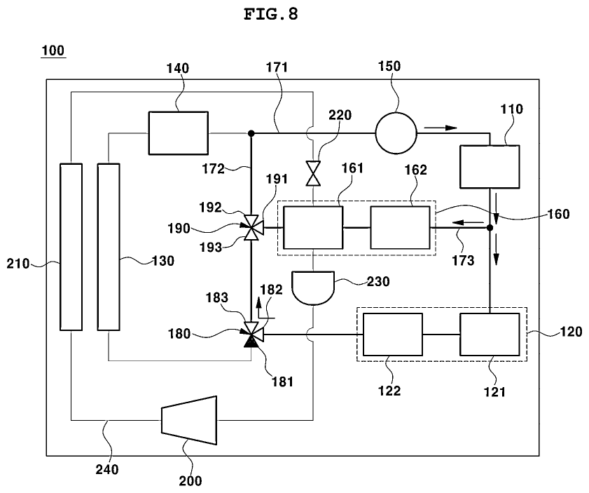

In addition, as shown in FIG. 8, a battery system 100 according to an embodiment of the present disclosure may be operated in a second heating mode using heat generated from the power conversion module 120 and the heater 162.

When the outside temperature is below zero, there is a limitation to raise the temperature of a battery 110 only with heat generation of a power conversion module 120. Therefore, when the outside temperature is less than a third temperature, it is necessary to raise the temperature of the battery 110 using the heater 162.

In order to control the battery system 100 in the second heating mode that uses heat generation of both the heater 162 and the power conversion module 120, the coolant flow in a second coolant line 172 and a third coolant line 173 is allowed, and the coolant flow to a radiator 130 is blocked.

To this purpose, a first coolant control valve 180 is controlled to close a first port 181 and open a second port 182 and a third port 183, and a second coolant control valve 190 is controlled to open a fourth port 191, a fifth port 192, and a sixth port 193.

Accordingly, the coolant that has passed through the battery 110 branches off and flows to the heater 162 and the power conversion module 120, and then the coolant heated while passing through the power conversion module 120 as well as the coolant heated by the heater 162 join at the rear end of the fifth port 192 of the second coolant control valve 190 and flow into the battery 110. In this case, a compressor 200 may not be driven because a chiller 161 is not used.

In addition, when it is desired to raise the temperature of the battery 110 using only the heater 162, the first coolant control valve 180 is controlled to close the first port 181 and the second port 182 or to close all of the first port 181, the second port 182 and the third port 183. The second coolant control valve 190 is controlled to open all the fourth port 191, the fifth port 192, and the sixth port 193.

As the embodiments of the present disclosure have been described in detail, the terms used in this specification and the claims should not be limited to the general meaning or dictionary meaning, and the scope of the present disclosure is not limited to the above-described embodiments, and various modifications and improvements of those having ordinary skill in the art using the basic concepts of the present disclosure defined in the following claims are also included in the scope of the present disclosure.

What is claimed is:

1. A movable battery system comprising:
an auxiliary vehicle connectable to a main vehicle; and
a battery system mounted on the auxiliary vehicle,
wherein the battery system of the auxiliary vehicle comprises:
a battery configured to provide electric power for driving the main vehicle;
a first coolant line that connects the battery, a power conversion module, a radiator, and a water pump to enable circulation of a coolant through the first coolant line;
a second coolant line that branches from the first coolant line between the radiator and the power conversion module and is connected to the first coolant line between the radiator and the water pump;
a third coolant line that branches from the second coolant line and is connected to the first coolant line between the battery and the power conversion module, wherein the third coolant line is configured to selectively allow the coolant to flow to a thermal management module for thermal management of the battery;
a first coolant control valve provided at a branch point of the second coolant line and configured to control a flow of the coolant;
a second coolant control valve provided at a branch point of the third coolant line and configured to control the flow of the coolant; and
a controller configured to control an operation mode of the first coolant control valve and the second coolant control valve.

2. The movable battery system of claim 1, wherein the first coolant control valve is provided with a first port connected to a front end of the radiator, a second port connected to a rear end of the power conversion module, and a third port connected to a front end of the water pump, and
the second coolant control valve is provided with a fourth port connected to a rear end of the thermal management module, a fifth port connected to the front end of the water pump, and a sixth port connected to the third port.

3. The movable battery system of claim 2, wherein the thermal management module comprises a heater to selectively heat the coolant transferred from the battery and a chiller to cool the coolant through heat exchange with a refrigerant.

4. The movable battery system of claim 3, wherein the chiller is connected to an electric compressor, an external condenser, and an electronic expansion valve through a refrigerant line, and the external condenser transfers the refrigerant that has exchanged heat with outside air to a front end of the chiller.

5. The movable battery system of claim 4, wherein the battery is cooled through the chiller and the radiator by the first coolant control valve controlled to open the first and second ports and to close the third port as well as the second coolant control valve controlled to open the fourth port and fifth port and to close the sixth port.

6. The movable battery system of claim 5, wherein the electronic expansion valve is disposed at the front end of the chiller and is controlled to cool the refrigerant transferred from the external condenser by decompressing the refrigerant.

7. The movable battery system of claim 2, wherein the battery is cooled through the radiator by the first coolant control valve controlled to open the first port and the second port and to close the third port as well as the second coolant control valve controlled to close at least the fifth port.

8. The movable battery system of claim 2, wherein a temperature of the battery is increased through heat generated by the power conversion module by the first coolant control valve controlled to close the first port and to open the second port and the third port as well as the second coolant control valve controlled to close the fourth port and to open the fifth port and the sixth port.

9. The movable battery system of claim 3, wherein a temperature of the battery is increased through heat generated by the power conversion module and through driving of the heater by the first coolant control valve controlled to close the first port and to open the second port and the third port as well as the second coolant control valve controlled to open the fourth port, the fifth port, and the sixth port.
